(19) United States
(12) Patent Application Publication
(10) Pub. No.: US 2011/0202477 A1
(43) Pub. Date: Aug. 18, 2011

(54) Method for Outsourcing Healthcare Billing and Collections

(76) Inventors: Kevin Kremer, Chico, CA (US); David Kremer, Encinitas, CA (US)

(21) Appl. No.: 12/705,528

(22) Filed: Feb. 12, 2010

(51) Int. Cl. G06Q 90/00

(52) U.S. Cl. 705/500

(57) ABSTRACT

A method is disclosed for outsourcing healthcare patient billing, thereby significantly reducing the billing and collections burden for healthcare providers, and simplifying the payment process for patients. Patients subscribe to a healthcare funding club, and establish one or more funding sources, such as an unsecured loan, a credit card, a pre-funded escrow account, a tax preferred funding account, and/or direct checking account withdrawal. Healthcare providers are paid at least a patient-responsible portion by the club, and the club obtains reimbursement from the funding source(s). The insurance portion of an insurance-covered service can be obtained by the healthcare provider, the healthcare club, or the patient. Branding can be included that is uniform across healthcare providers, and/or specific to each healthcare provider. A healthcare club card can be provided to the patient and used to pay for healthcare services, and consolidated, periodic healthcare expense statements can be provided to patients.

### FIELD OF THE INVENTION

The invention generally relates to methods of healthcare billing, and more specifically to methods for outsourcing of healthcare billing.

### BACKGROUND OF THE INVENTION

A significant amount of effort is expended by every healthcare provider in billing and collecting payment for the healthcare services that they provide. In certain cases where healthcare insurance is not involved, such as in cosmetic surgery, chiropractic medicine, veterinary medicine, or cosmetic dentistry, it is highly important to ensure that a method of payment has been identified and secured before a procedure is performed. Typically, before scheduling a procedure, staff at a cosmetic surgery, chiropractic, veterinary, or cosmetic dentistry clinic will discuss payment options with a patient, such as a secured or unsecured medical loan. If the patient wishes to take advantage of one of these options, the staff may even assist the patient in applying and obtaining approval from a financing organization. On the other hand, if the patient wishes to pay from his or her own funds, for example using a secured home equity line of credit or an unsecured, general purpose credit card, then the clinic is often required to place its trust in the patient and assume the risk that payment will be made.

Once the procedure has been performed, the healthcare provider is often required to invoice a loan company, a credit card company, and/or the patient directly, so as to receive payment. Since different patients may select different payment options, the staff of a typical provider of healthcare procedures must be trained and equipped to invoice and collect from many different funding sources. This requirement places a significant and costly staffing and overhead burden on the clinic.

Beyond the frustrations and staffing expense that this process requires, the current system of healthcare billing can also result in significant delays before a healthcare provider finally receives full payment for services rendered. As in any other profession, “time is money” for a healthcare provider, and so these significant delays in receiving payment result in additional costs to the healthcare provider, which must be passed on to patients.

Even when healthcare insurance is involved, there is nearly always a portion of the payment for which the patient is responsible, and consequently the healthcare provider must assume the risk of payment for that portion, and pursue all of the steps described above for collection of the patient portion from the patient.

There are also numerous deficiencies in the present system from the standpoint of patients, since patients are typically asked to deal with healthcare billing issues regarding the portion for which they are responsible long after services are rendered, and often during a time when they are still recovering from a significant medical procedure.

Credit-based business methods have been proposed that would allow a patient to pay his or her portion of healthcare expenses more conveniently and flexibly using a single credit account that would draw on one or more healthcare funding accounts and pre-arranged credit sources. However, these approaches do not lessen the billing and collecting burden on healthcare providers, since it remains the responsibility of the provider to discuss funding options with each patient, help each patient choose an option, and then obtain payment from the funding source selected by each patient. These approaches increase the billing and collecting burden on healthcare providers because it requires them to be familiar with multiple funding sources and to manage collections from multiple funding sources, sometimes even when obtaining reimbursement for a single healthcare service provided to a single patient.

### SUMMARY OF THE INVENTION

The present invention is a business method that provides outsourcing of healthcare billing and/or collection to and from patients for healthcare providers, including cosmetic surgery clinics, cosmetic dentistry clinics, doctors' offices, chiropractors, dentists' offices, clinics, hospitals, pharmacies, and veterinary facilities of all kinds. A healthcare service provider practicing the claimed method typically requires that all of the provider's patients subscribe to a healthcare funding club. If a new patient does not already belong to the club, the healthcare provider refers and/or assists the patient in subscribing to the club.

As part of the subscription process, the provider and/or the healthcare funding club assists the patient in selecting one or more funding sources, which can include an unsecured loan, a credit card, a pre-funded escrow account, a tax preferred funding account, direct withdrawal from a patient's checking account, and other funding sources. A credit check is performed on the patient and a line of credit is granted to the patient. After a healthcare service is performed, the healthcare provider invoices and receives payment of the patient-responsible portion from the club, while the club takes responsibility for obtaining reimbursement from the funding sources selected by the patient, except for insurance reimbursement, which in some embodiments is handled directly by the patient. Since patients fund their procedures through the healthcare funding club, most of the patient invoicing and collecting burden is removed from the healthcare service provider, since the healthcare service provider is no longer required to spend time invoicing and collecting from multiple patient funding sources and deals directly with one organization, the healthcare funding club.

In some embodiments, when healthcare services are covered by healthcare insurance, the covered portion is invoiced directly to the insurance company, while the healthcare funding club provides immediate payment of the portion for which the patient is responsible. In other embodiments, when healthcare services are covered by healthcare insurance, the healthcare provider invoices and receives full payment for the medical service from the club. In some of these embodiments, the healthcare funding club then obtains reimbursement for the covered portion directly from the healthcare insurance provider, while in other of these embodiments the healthcare funding club obtains reimbursement of the full amount from the patient's funding source(s), and the patient obtains reimbursement of the covered amount from the healthcare insurance provider.

In some embodiments, branding is included to build healthcare provider and patient recognition and loyalty. Once a patient has subscribed to the healthcare funding club, the patient is likely to continue using the healthcare provider that accepts payment through the healthcare funding club, and the patient is also likely to seek out other healthcare providers that accept payment through the healthcare funding club. The branding can be uniform across many healthcare providers, and/or can include custom branding for separate healthcare providers.

The present invention relieves healthcare providers of a billing and collection burden, and provides them with immediate payment of at least the patient responsible portion due for services. The present invention also benefits patients by offering a variety of funding options that can be pre-selected and pre-arranged. Payment can then by made by the patient by means of a simple and uniform payment method, which in preferred embodiments is similar to using a credit card. The method typically also provides consolidated statements to patients regarding all healthcare expenses paid using the present invention and reimbursements made to the healthcare funding club.

The present invention is a method for providing outsourcing of medical billing. The method includes enrolling a patient as a member in a healthcare funding club, identifying at least one medical funding source for the patient, paying to a medical provider a payment on behalf of the patient that is at least equal to a patient responsible portion of a cost of a medical service performed for the patient by the medical provider, and obtaining a reimbursement of the payment from the at least one medical funding source.

In preferred embodiments, identifying at least one medical funding source for the patient includes establishing a medical funding source for the patient, and/or verifying the funding ability of a medical funding source available to the patient.

In some preferred embodiments, at least one medical funding source identified for the patient a medical insurance provider, an unsecured loan, a secured line of credit, an unsecured line of credit, a checking account that can be auto-debited, a medical credit card, a tax-preferred medical funding account, oran escrow account pre-funded by the patient.

Certain preferred embodiments further include providing a card to the patient that can be used by the patient in the manner of a credit card to make a payment to a medical provider. And in some of these embodiments, the card is usable in the manner of a credit card to make a payment to a non-medical vendor.

Various preferred embodiments further include requiring the medical provider to accept only patients who are members of the healthcare funding club. Other preferred embodiments further include establishing a brand identity for at least one of the healthcare funding club and a medical provider wiling to receive payments from the healthcare funding club.

In preferred embodiments, the payment paid by the healthcare funding club to the medical provider on behalf of the patient is equal to the patient responsible portion, thereby placing on the medical provider responsibility for obtaining payment of an insurance responsible portion.

In other preferred embodiments, the payment paid by the healthcare funding club to the medical provider on behalf of the patient includes both the patient responsible portion and an insurance responsible portion. In some of these preferred embodiments reimbursement for the insurance responsible portion is obtained by the healthcare funding club from a medical insurance provider. In other of these preferred embodiments reimbursement for the insurance responsible portion is obtained by the healthcare funding club from the patient, thereby placing responsibility on the patient for obtaining reimbursement of the insurance responsible portion from a medical insurance provider.

In certain preferred embodiments, a member portion of the reimbursement is obtained from the patient in a manner substantially identical to the manner in which payment is obtained from customers by an issuer of a credit card. And in various preferred embodiments payments made by the healthcare funding club on behalf of the patient are limited so as not to exceed an aggregate reimbursement limit of all funding sources identified for the patient.

In some preferred embodiments, interest is charged by the healthcare funding club to the patient if payment of a member portion of the reimbursement which is directly payable by the patient is not obtained from the patient within a specified amount of time. In other preferred embodiments, a fee is charged to the medical provider whenever a payment is made to a medical provider on behalf of a patient, the fee being on a per-transaction basis and/or a percentage of transaction amount basis.

In various preferred embodiments a fee is charged to the medical provider at regular time intervals. And in some of these embodiments, the fee is charged to the medical provider at least one of weekly, monthly, and yearly.

And some preferred embodiments further include periodically providing to the patient a consolidated statement that summarizes health care funding club activity during a specified time period, including all payments made on behalf of the patient during the time period, all reimbursements received from the patient during the time period, and all reimbursements due from the patient as of an end of the time period.

### BRIEF DESCRIPTION OF THE DRAWINGS

FIG. 1A is a flow diagram that illustrates a typical healthcare billing process of the prior art for a procedure not covered by healthcare insurance;

FIG. 1B is a flow diagram that illustrates a preferred embodiment of the present invention applicable to a healthcare procedure that is not covered by healthcare insurance;

FIG. 1C is a flow diagram that illustrates establishment of a branded relationship between a healthcare funding club of the present invention and a healthcare provider;

FIG. 2A is a flow diagram that illustrates a typical healthcare billing process of the prior art for a patient with healthcare insurance;

FIG. 2B is a flow diagram that illustrates a preferred embodiment method of the present invention for paying healthcare expenses on behalf of a healthcare club member who is covered by healthcare insurance wherein the healthcare services provider submits a claim to the healthcare insurance company;

FIG. 2C is a flow diagram that illustrates a preferred embodiment method of the present invention for paying healthcare expenses on behalf of a healthcare club member who is covered by healthcare insurance wherein the healthcare club submits a claim to the healthcare insurance company; and

FIG. 2D is a flow diagram that illustrates a preferred embodiment method of the present invention for paying healthcare expenses on behalf of a healthcare club member who is covered by healthcare insurance wherein the patient submits a claim to the healthcare insurance company.

### DETAILED DESCRIPTION OF PREFERRED EMBODIMENTS

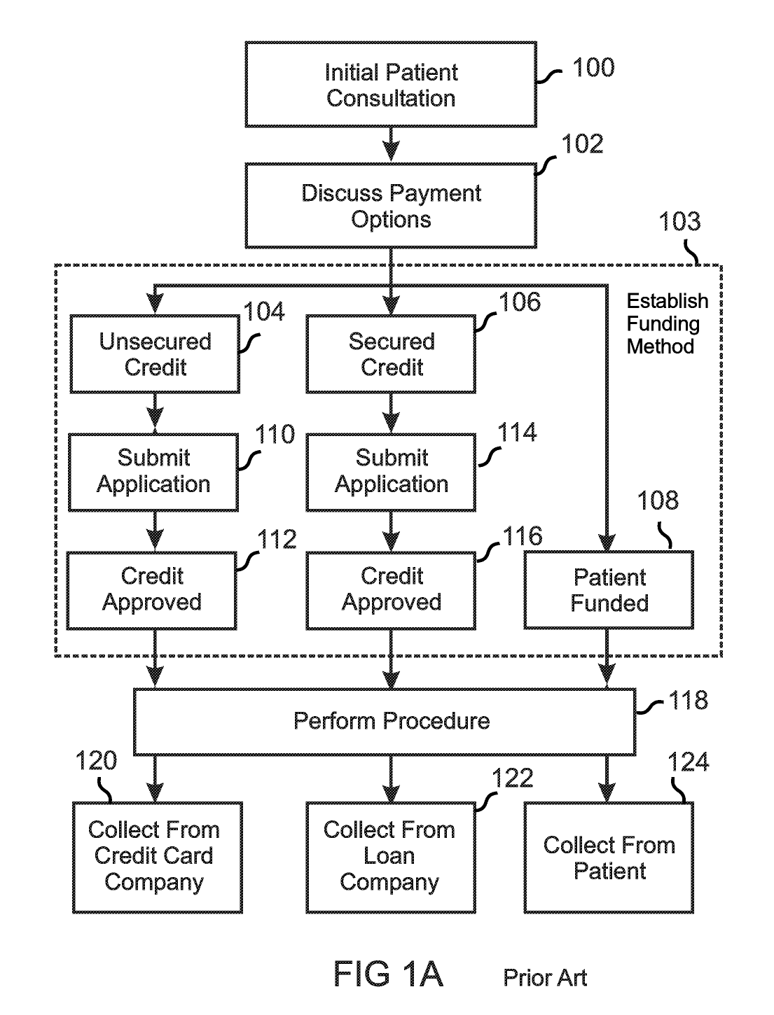

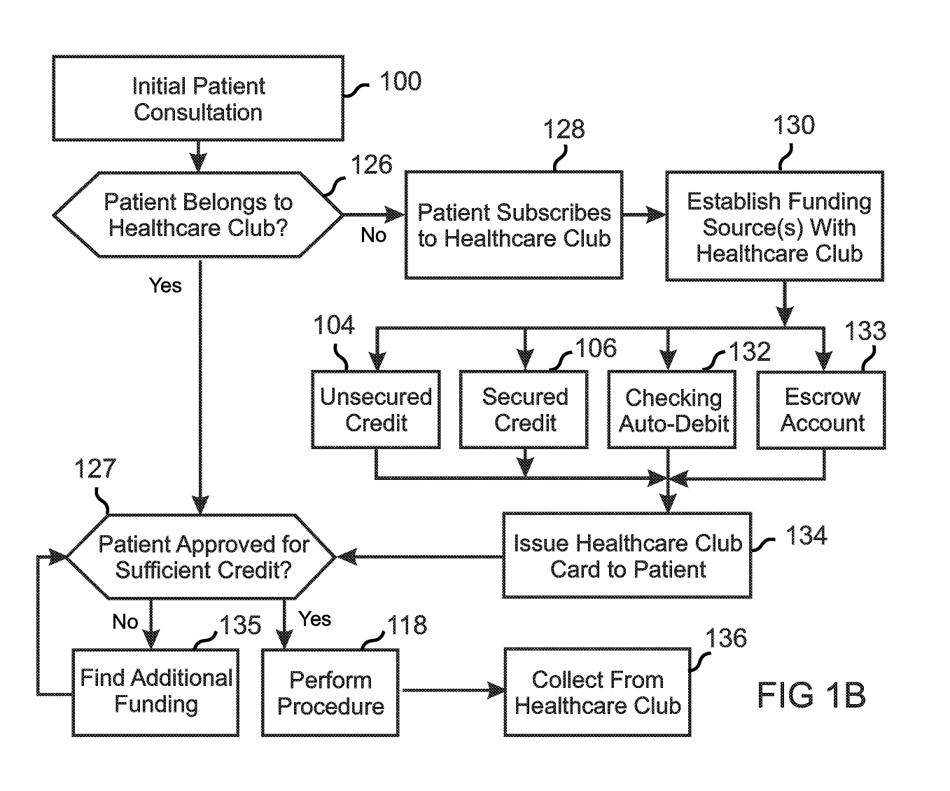

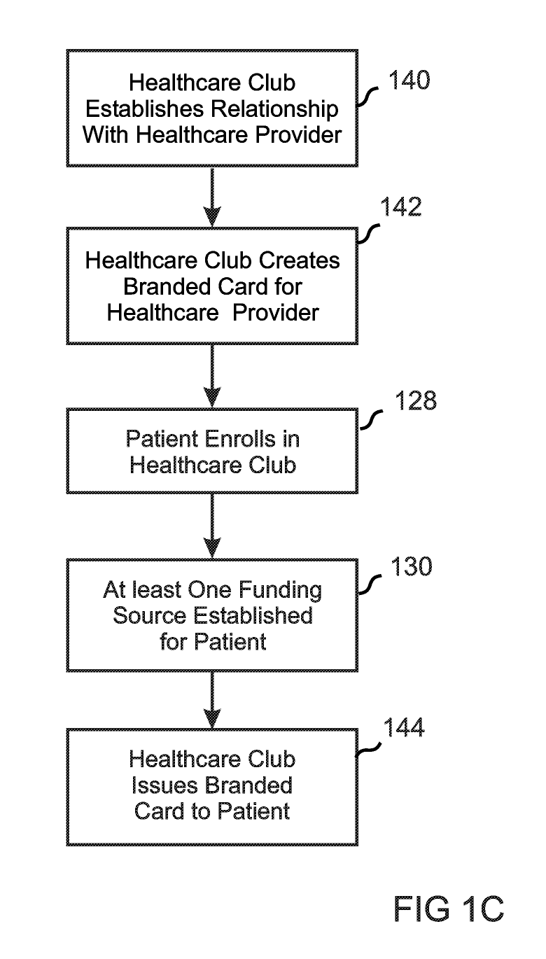

FIG. 1A illustrates a generally known and widely implemented process for invoicing and obtaining payment for healthcare services such as cosmetic surgery, chiropractic services, veterinary medicine, and cosmetic dentistry that are not typically covered by healthcare insurance. The process begins with a patient consultation 100 during which healthcare provider staff discusses payment options 102 with the patient so as to establish a funding method 103 for the healthcare procedure. Funding methods can include unsecured credit such as a credit card 104, a secured line of credit 106 such as a home equity credit line, and/or direct payment by the patient 108, possibly by direct withdrawal from the patient's checking account. If unsecured credit 104 is to be included as a funding source, and if the patient does not already have sufficient unsecured credit available, it may be necessary to submit 110 an application to a credit organization such as a healthcare credit company and obtain approval 112. Similarly, if a secured line of credit 106 is to be used, then it may be necessary to apply for the credit line 114 and be approved 116.

Once the funding method has been established 103, the healthcare procedure is performed 118, after which the healthcare provider is required to seek payment from a credit card company 120, a loan company 122, and/or directly from the patient, for example by direct withdrawal from the patient's checking account, depending on the funding method that was initially established 103. Since there is a wide variety of funding options available, and since, in general, each patient will make a different selection of payment options, each case imposes more or less unique requirements on the healthcare provider staff, thereby placing a significant financial burden on the healthcare provider in billing and collecting payment.

FIG. 1B illustrates a preferred embodiment of the present invention that is applicable to healthcare procedures that are not covered by healthcare insurance. During the initial consultation with the patient 100, the patient is informed that the healthcare provider requires that the patient apply to the healthcare club. If the patient already subscribes to the healthcare club 126, and is approved for sufficient credit 127, then the healthcare procedure can be performed 118 with no further discussion. If the patient does not already subscribe to the healthcare club 126, the patient is referred to the healthcare club, and the healthcare club staff carries out all necessary steps to enroll the patient as a healthcare club member 128. Through consultation with the healthcare provider staff and/or the healthcare club staff, one or more funding methods 130 are identified for the patient, and this process continues 135 until sufficient credit approval and/or other funding has been identified. Sources of funding can include an unsecured source of funds 104 such as an unsecured loan or credit card, a secured source of credit 106 such as a home equity line, direct withdrawal from a patient's checking account 132, and/or an escrow account 133 that is pre-funded by the patient before the procedure is performed. Wherever appropriate, a check of the patient's credit can be performed and/or a level of credit determined.

Once the patient is enrolled in the healthcare club and at least one funding source has been identified, the healthcare club issues a healthcare club card and/or ID number 134 to the new healthcare club member that can be presented by the healthcare club member to the healthcare provider when the healthcare procedure is performed 118. In preferred embodiments, a temporary card and/or other verification (such as ID number) is supplied so that an initial procedure can be performed 118 even before the official card has been issued. After performing the procedure 118, the healthcare provider need only invoice the healthcare club so as to receive payment. It is then the responsibility of the healthcare club to obtain reimbursement from the funding source or sources identified for the patient. The invoicing and collecting burden on the healthcare provider is thereby greatly reduced.

In similar embodiments, if a procedure is covered by healthcare insurance, payment is made to the healthcare provider exactly as is illustrated in FIG. 1B, with the additional steps that either the healthcare club or the patient files a claim with the healthcare insurance company and obtains reimbursement therefrom.

FIG. 1C illustrates the establishment of a relationship between a healthcare payment club and a healthcare provider in a preferred embodiment wherein the healthcare payment club includes branding to further enhance the acceptance and success of the healthcare funding program. Initially, the healthcare club establishes a relationship 140 with the healthcare provider. In some embodiments, this includes agreement by the healthcare provider to require all patients to subscribe to the healthcare club. The healthcare club then creates a branded card and/or ID number 142 for the healthcare provider, typically including the name and logo of the healthcare provider. This serves to increase the loyalty of the patient to the healthcare provider, since the healthcare card can be used for additional procedures in the future to greatly simplify payment by the patient. In some embodiments where the healthcare club is well known, the branding may include identification of the healthcare club, either exclusively or in combination with branding that identifies the healthcare provider. This serves as an incentive for other healthcare providers to establish relationships with the healthcare club, since patients who are already members of the club will be likely to select healthcare providers who accept payment through the club.

When a patient enrolls in the healthcare club 128, and a funding source is identified for the patient 130, a branded healthcare club card and/or ID number is then issued 144 to the patient.

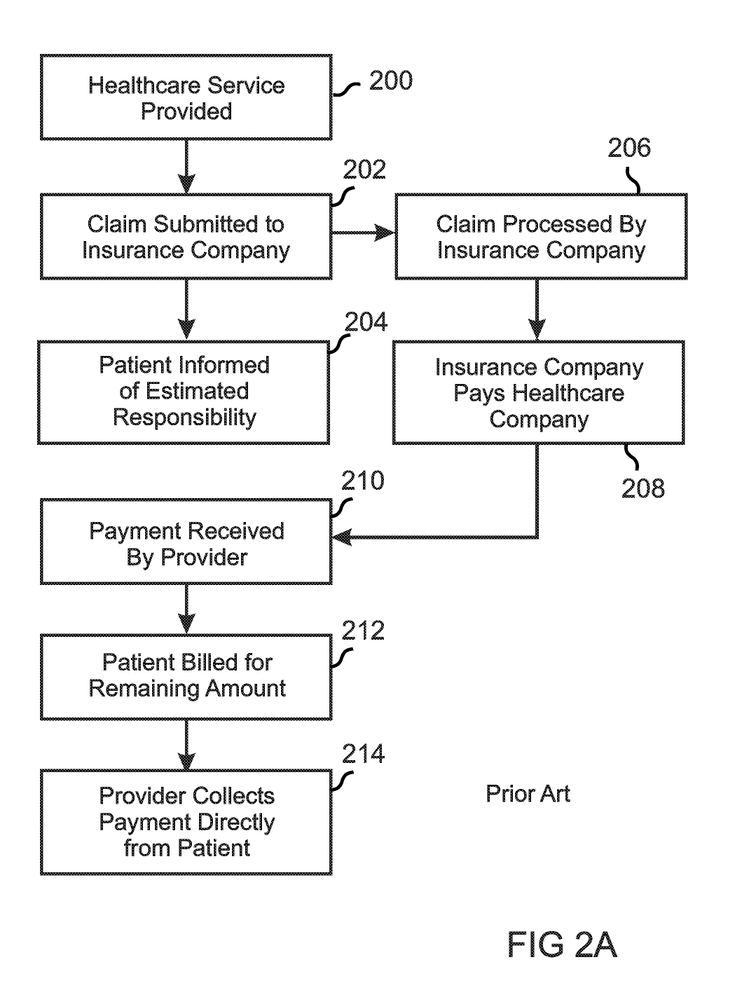

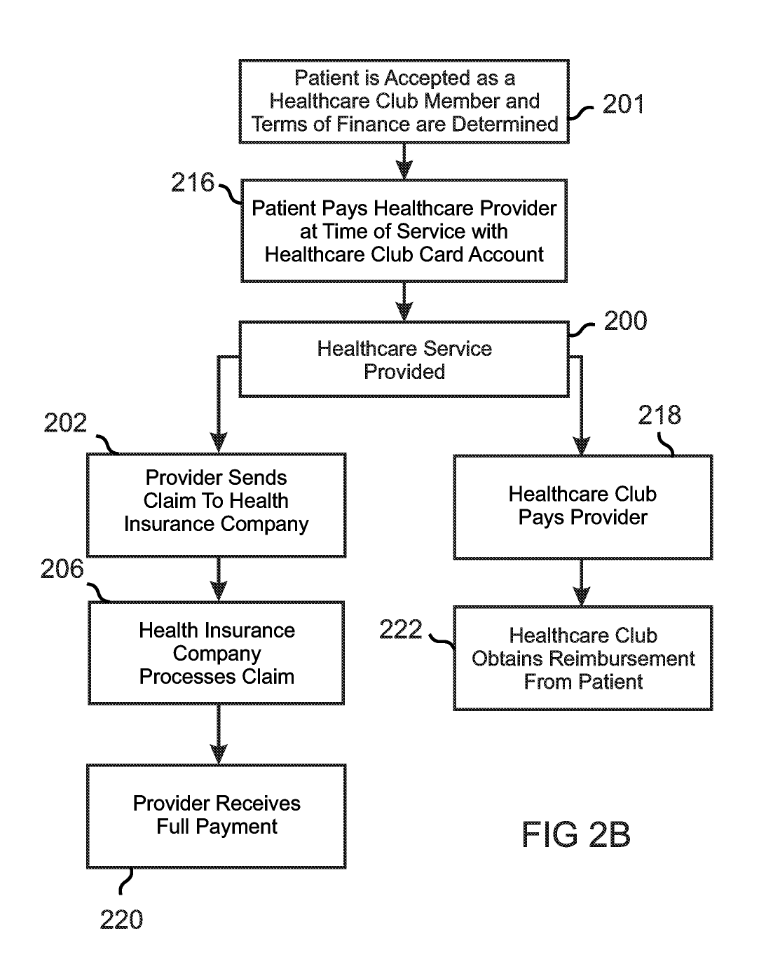

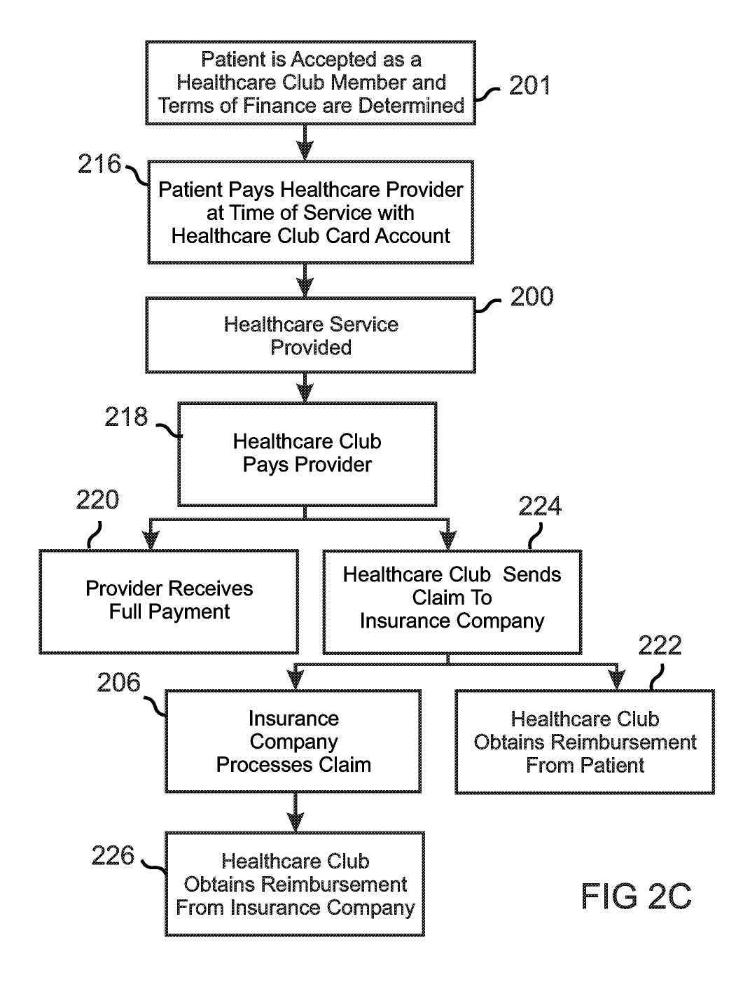

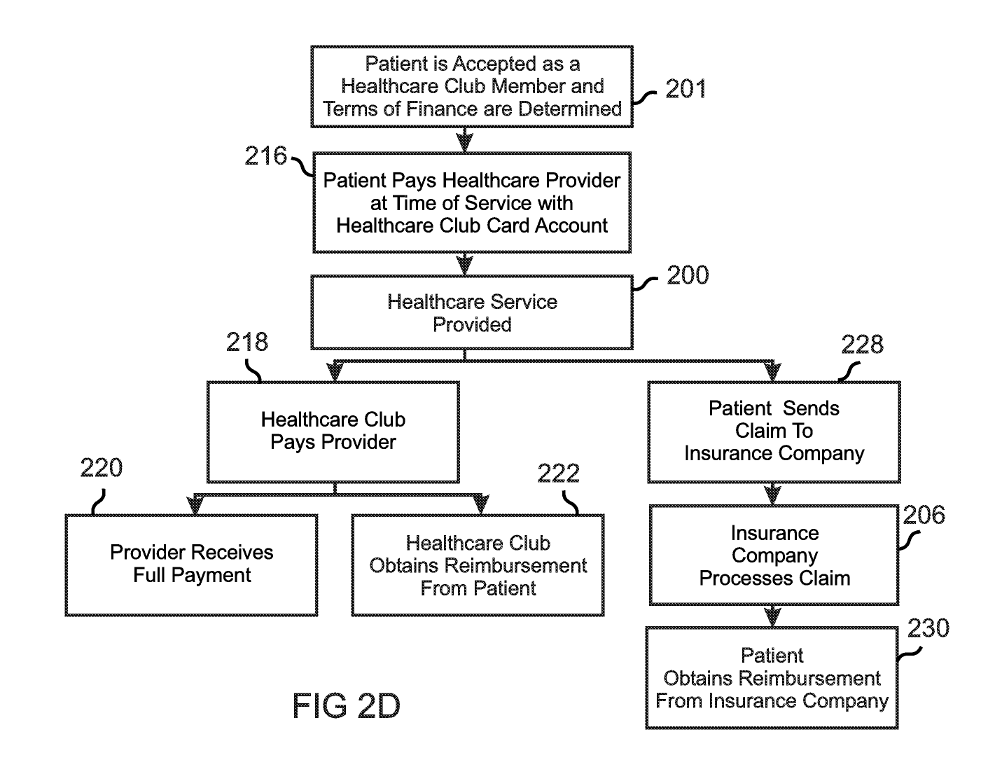

FIG. 2A illustrates a generally known and widely implemented process for invoicing and obtaining payment for healthcare services when a healthcare procedure is covered by healthcare insurance. It is typical for a healthcare provider in such cases to record and verify information regarding a patient's healthcare insurance even before the healthcare service is provided 200. Once the healthcare service is provided 200, the healthcare provider submits a claim to the patient's healthcare insurance company 202, and also gives an estimate to the patient as to what the patient can expect to be his or her payment responsibility 204. This estimate often indicates a statement of the “full charges” for healthcare services rendered, which can be confusing to the patient since these full charges almost never apply to services covered by healthcare insurance.

The insurance company eventually processes 206 and pays 208 the insurance claim, and the payment is received by the healthcare provider 210. At this point, the patient is billed for any co-pays, deductibles, or other remaining charges 212 that are the responsibility of the patient.

The patient then pays the invoice 214, possibly using a standard credit card so as to spread the payment over time. Depending on the method of payment, such as a credit card, the healthcare provider may be required to collect payment from a credit card company or other credit provider.

The entire process according to FIG. 2A can be lengthy, confusing, and frustrating for both the healthcare provider and the patient. Many steps are required of both the healthcare provider and the patient, and significant delays are endured before the healthcare provider finally receives full payment and before the patient finally stops receiving and paying bills.

FIG. 2B is a flow diagram that illustrates an embodiment of the present invention applicable to a patient who is covered by health insurance. In the embodiment of FIG. 2B, once a patient is accepted by the healthcare club and terms of finance are determined 201, the patient pays the healthcare provider 216 and the healthcare service is provided 200. The healthcare provider then sends a claim 202 to the health insurance company, the health insurance company processes the claim 206, and the healthcare provider receives full payment 220. In similar embodiments, the claim is sent to the insurance company by the healthcare club. Meanwhile, the healthcare club pays the patient responsible portion to the healthcare provider 218, and then obtains reimbursement from the patient 222 according to the funding source or sources previously identified for the patient.

FIG. 2C is a flow diagram that illustrates an embodiment similar to the embodiment of FIG. 2B, except that the healthcare club pays the full amount to the healthcare provider 218, thereby providing immediate full payment to the healthcare provider 200. The healthcare club then sends the claim to the healthcare insurance company 224, and obtains reimbursement therefrom 226, while also obtaining reimbursement of the patient responsible portion from the patient 222.

FIG. 2D is a flow diagram that illustrates an embodiment similar to the embodiment of FIG. 2B, except that after the healthcare club pays the provider 218 and the provider received full payment 220, the healthcare club received full reimbursement from the patient 222, while the patient sends the claim to the health insurance company 228, the insurance company processes the claim 206, and the patient obtains reimbursement directly therefrom 230.

It should be understood that throughout this document the terms “healthcare insurance,” “healthcare insurance company” are intended to refer to any available source of healthcare expense payment and/or reimbursement that is not directly funded by the assets of the patient. These include privately purchased health insurance, employer-subsidized health insurance, Medicare, Medicaid, and all similar sources of healthcare expense coverage.

Other modifications and implementations will occur to those skilled in the art without departing from the spirit and the scope of the invention as claimed. Accordingly, the above description is not intended to limit the invention except as indicated in the following claims.

What is claimed is:

1. A method for providing outsourcing of medical billing, the method comprising:
enrolling a patient as a member in a healthcare funding club;
identifying at least one medical funding source for the patient;
paying to a medical provider a payment on behalf of the patient that is at least equal to a patient responsible portion of a cost of a medical service performed for the patient by the medical provider; and
obtaining a reimbursement of the payment from the at least one medical funding source.

2. The method of claim 1, wherein identifying at least one medical funding source for the patient includes at least one of:
establishing a medical funding source for the patient; and
verifying the funding ability of a medical funding source available to the patient.

3. The method of claim 1, wherein at least one medical funding source identified for the patient is one of:
a medical insurance provider;
an unsecured loan;
a secured line of credit;
an unsecured line of credit;
a checking account that can be auto-debited;
a medical credit card;
a tax-preferred medical funding account; and
an escrow account pre-funded by the patient.

4. The method of claim 1, further comprising providing a card to the patient that can be used by the patient in the manner of a credit card to make a payment to a medical provider.

5. The method of claim 4, wherein the card is usable in the manner of a credit card to make a payment to a non-medical vendor.

6. The method of claim 1, further comprising requiring the medical provider to accept only patients who are members of the healthcare funding club.

7. The method of claim 1, further including establishing a brand identity for at least one of the healthcare funding club and a medical provider wiling to receive payments from the healthcare funding club.

8. The method of claim 1, wherein the payment paid by the healthcare funding club to the medical provider on behalf of the patient is equal to the patient responsible portion, thereby placing on the medical provider responsibility for obtaining payment of an insurance responsible portion.

9. The method of claim 1, wherein the payment paid by the healthcare funding club to the medical provider on behalf of the patient includes both the patient responsible portion and an insurance responsible portion.

10. The method of claim 9, wherein reimbursement for the insurance responsible portion is obtained by the healthcare funding club from a medical insurance provider.

11. The method of claim 9, wherein reimbursement for the insurance responsible portion is obtained by the healthcare funding club from the patient, thereby placing responsibility on the patient for obtaining reimbursement of the insurance responsible portion from a medical insurance provider.

12. The method of claim 1, wherein a member portion of the reimbursement is obtained from the patient in a manner substantially identical to the manner in which payment is obtained from customers by an issuer of a credit card.

13. The method of claim 1, wherein payments made by the healthcare funding club on behalf of the patient are limited so as not to exceed an aggregate reimbursement limit of all funding sources identified for the patient.

14. The method of claim 1, wherein interest is charged by the healthcare funding club to the patient if payment of a member portion of the reimbursement which is directly payable by the patient is not obtained from the patient within a specified amount of time.

15. The method of claim 1, wherein a fee is charged to the medical provider whenever a payment is made to a medical provider on behalf of a patient, the fee being on at least one of a per-transaction basis and a percentage of transaction amount basis.

16. The method of claim 1, wherein a fee is charged to the medical provider at regular time intervals.

17. The method of claim 16, wherein the fee is charged to the medical provider at least one of weekly, monthly, and yearly.

18. The method of claim 1, further comprising periodically providing to the patient a consolidated statement that summarizes health care funding club activity during a specified time period, including all payments made on behalf of the patient during the time period, all reimbursements received from the patient during the time period, and all reimbursements due from the patient as of an end of the time period.
